(19) United States
(12) Patent Application Publication
(10) Pub. No.: US 2025/0161130 A1
(43) Pub. Date: May 22, 2025

(54) Blue

(71) Applicant: Andrew F Kohler, Amissville, VA (US)

(72) Inventor: Andrew F Kohler, Amissville, VA (US)

(21) Appl. No.: 18/517,203

(22) Filed: Nov. 22, 2023

(51) Int. Cl. A61G 7/075; A61G 13/12

(52) U.S. Cl. CPC A61G 7/0755; A61G 13/1245; A61G 2200/325; A61G 2200/56; A61G 2200/58; A61G 2210/30

(57) ABSTRACT

This device serves as an inflatable deployment technology and assists practitioners and rapid response personnel during code blue events in the hospital setting. A true code blue refers to a cardiac arrest entails in acting advanced care life support (ACLS) and a crash cart is brought to the scene for rapid access to needed medicines and devices. Blue will serve as a deployable leg raise to assist in volume resuscitation, applicable in distributive and hypovolemic shock states, as well as provide a workspace platform for procedures and necessary preparation, increasing care efficacy and timely intervention. Finally, quick reference guides will be displayed to promote team cohesion and fluid delivery of care.

### BACKGROUND ON THE PROBLEM AND THE BLUE SOLUTION

In the hospital, when a patient or visitor suffers a cardiac arrest for any reason the protocol that is enacted is called “Code Blue”. There is generally a team or appointed personnel on call at any one time to respond when this code is activated on campus. A true code blue involves a cardiac arrest, however this team may be activated as a “Rapid Response” measure when a patient is identified as deteriorating and urgent bedside assessment is requested, given the threat of impending cardiac arrest, for example if the patient is felt to be suffering from a shock state.

ACLS is enacted and a protocol of life saving steps is followed based upon etiology, medical history, and the course of the intervention. Part of the protocol generally includes someone being responsible for locating and bring a crash cart into the room. This cart is a mobile means of securely housing necessary medications, devices, and procedural kits used during a code blue. Additional roles and responsibilities during this code include a timekeeper, airway personnel, medication personnel, CPR personnel, and the practitioner in charge of running the code.

Blue serves as an asset in multiple points throughout a code blue or shock protocol intervention. One barrier to success during these codes is a chaotic sequence of events. There are generally too many personnel in a small hospital room. As a result, there is no workstation available for emergent vascular access procedures, intubation equipment, necessary medication orchestration, or charting. Blue serves as a hub and literal platform to facilitate an efficient and effective code blue.

This device will remain folded and stored on the side of the crash cart. When needed, Blue can be unfolded and placed under the patient's legs. When connected to the wall or external pump, the device inflates to create a table to serve as a workstation and material containment area. A second region inflates below, serving the role of a leg raise utilized to increase vascular return to the heart. In confined spaces, the leg raise is often ruled out given lack of personnel, space, or accessibility to perform to maneuver. Finally, the 1-2-3 step instructions on the devices sides and bottom allow for important team orientation.

### How the Invention is an Improvement Over Existing Technology

Currently, it is up to the lead provider, or potentially team members, to instill a calm, cohesive, and efficient code blue sequence. Generally, the protocol options are enacted from memory by the humans in the room. Beyond the benefit of reducing chaos, the current “workstation” for procedures and medication administration is on top of the patient's body and bed sheets, often with the patient undergoing CPR and used procedural needles remaining loose on the bed for periods of time. Regarding the leg raise aspect, this maneuver is often unable to be given inability for personnel to have hands available or climb into the bed and lift the patient's legs in a sustainable manner. Finally, large, quick reference overviews displayed on the device are generally currently only available in one copy on the crash cart as a comprehensive protocol.

### Individual and Business Demographics that would Use this Invention

Health care institutions, emergency department, urgent cares, outpatient medical facilities.

### Description of Invention Benefits to its Users

Any ability to increase the percent chance of success during a code blue is of significant benefit to the patient. The benefit to the provider team includes decreased patient mortality, increased personnel safety, and improved efficiency. An unforeseen benefit may include increased job satisfaction.

### BRIEF DESCRIPTION OF INVENTION

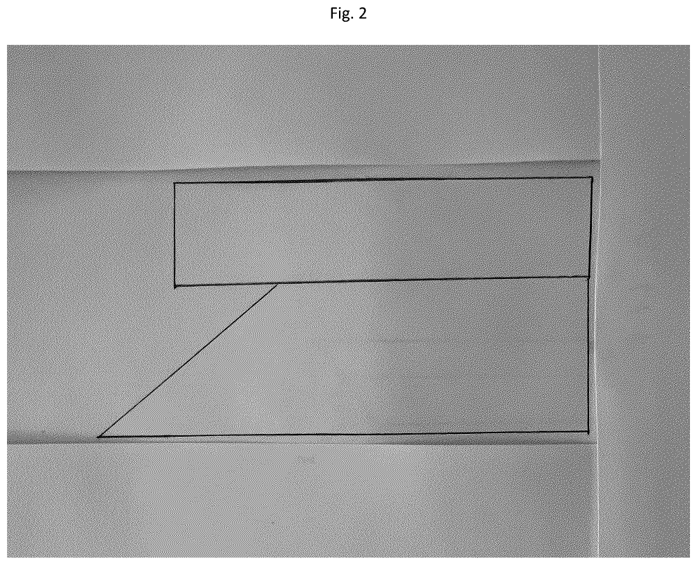

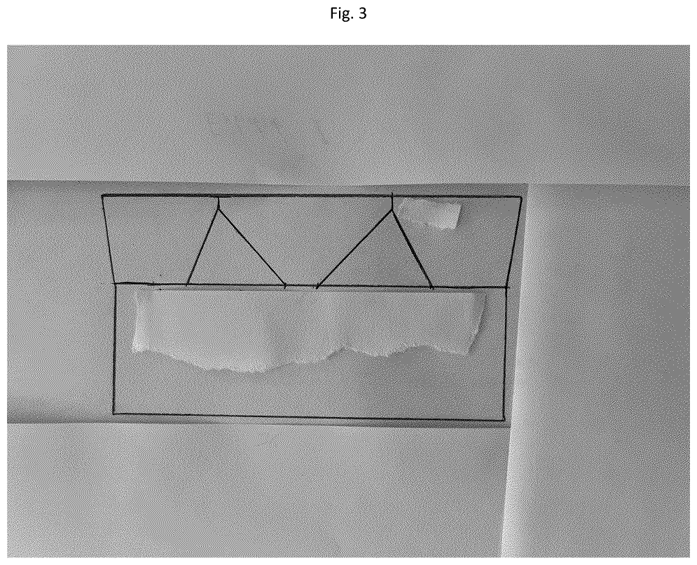

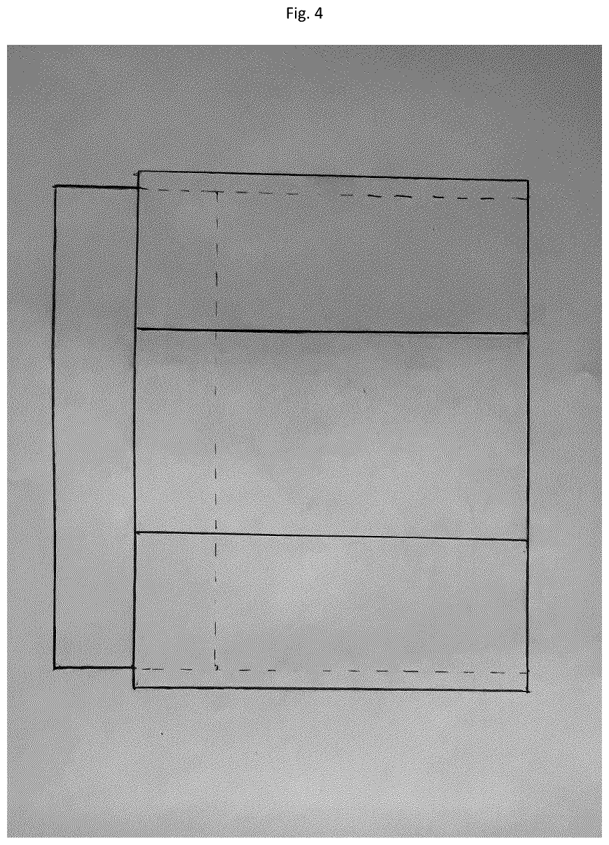

The device is an inflatable polypropylene balloon. The base is 3 feet long by three feet wide. As viewed from the side, this inflatable bladder begins at ground level on the left (see FIG. 2) and widens at a 45 degree angle for 11.3 inches and levels back off to the horizontal plane 10 inches above ground level and proceeds parallel at 0 degrees for the remaining 28 inches. The same angulation is maintained throughout the entire width and serves as a wedge beginning at the patients coccyx and raising the thighs at a 45 degree angle, then leveling off so that the lower legs are level with the ground, yet 10 inches above the bed.

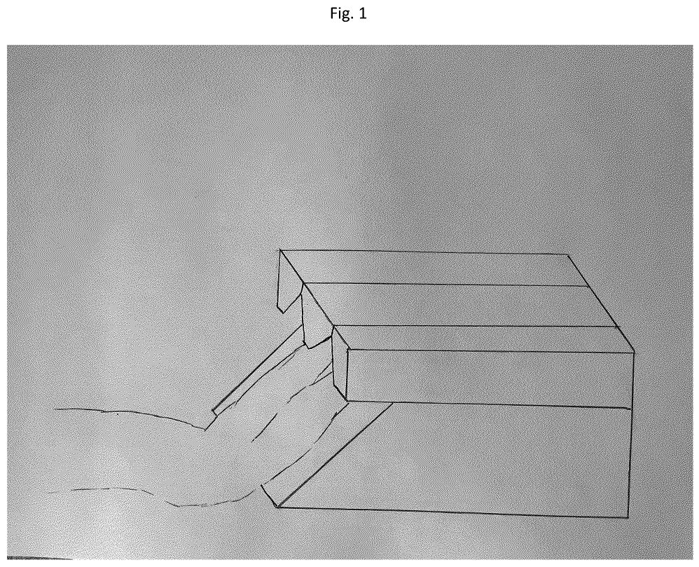

Lastly, three compartments will extend from the flat plane upon which the lower extremities will rest. These compartments will run 30 inches in length from the foot end of the platform, extending over the wedge down slope by 2 inches. Two of them on the left and right aspects of the device, with the 3rd directly in the center, between the patient's legs extending from foot to above the knee as the patient is lying flat (see FIG. 1). These compartments will be wedge shaped with the wide base portion of the wedge facing upwards creating a thick “T” and they're upside-down apexes connecting to the leg platform with three inches of connection width. These compartments will fill so that the wedge bases touch one another and create a platform above the patient's legs, 30 inches in length and 42 inches in width. The middle compartments will have a width of 18 inches in the outer two compartments will each have a width of 12 inches.

When fully inflated these compartments will have a height of eight inches. The total height of the device will be 18 inches. Prior to inflation, the device will be folded in a 15 by 15 length and width carrying case, 3 inches in thickness. This case will come with a hook, which is installed on the side of the crash cart. Given hygiene concerns and ability to successfully refold the device, this will be a single use item.

### PARTS AND COMPONENTS IDENTIFICATION

Each part and component of the Invention with assigned reference number and title

| REFERENCE | |
|---|---|
| NUMERAL | PART NAME |
| 1 | Inflatable balloon - main body |
| 2 | Inflatable balloon - center platform wedge |
| 3 | Inflatable balloon - side platform wedges |
| 4 | Pump access valve |
| 5 | Carrying Case |

### INVENTION DETAILED SPECIFICATION

| PART NUMBER | PART DESCRIPTION |
|---|---|
| 1 | The main body of the device is an inflatable polypropylene air |
| | bladder with a base dimension of 36 inches long by 36 inches wide. |
| | The height of the platform is 10 inches, with the platform plateau |
| | running the first 28 inches of the length, and then turning at a 45- |
| | degree angle downwards to meet the bottom edge at ground level. |
| | The shape of this air bladder is essentially #1. a 20 inch long by 36 |
| | inch wide by 10-inch rectangle, connected to # 2. a triangular |
| | wedge that is 8 inches long by 36 inches wide by 10 inches high |
| | with an 11.3-inch-long arm of the triangle |
| 2 | The center of the three inflatable wedges, which makes up the |
| | workspace platform, will be 30 inches in length beginning at the |
| | bottom of the devices base air bladder plateau. Four inches of the |
| | wedge's right angle is absent to allow four inches of connection |
| | with the wedge and the base air bladder. The longest edge will face |
| | upwards, opposite the right angle. The length of this surface will |
| | be 18 inches when fully inflated. The 45-degree edge angles of this |
| | triangle will be absent to form a 2 inch flat 90 degrees surface to |
| | the long arm of the triangle, which will allow for approximation |
| | when the parts are inflated. |
| 3 | The two inflatable side wedges, which make up the workspace platform will |
| | also be 30 inches in length, beginning at the bottom of the devices base air |
| | bladder plateau. They will also be a polypropylene air bladder connected to |
| | the main air bladder below by a width of 6 inches. The shape will be a |
| | rectangle with the opposing edge 12 inches in width, creating the flat surface |
| | that is the workstation table. The total height will be 8 inches to match that |
| | of the middle wedge. The final two inches that meets the middle wedge will |
| | be absent and instead have a flattened surface at a right angle to the table |
| | plateau allowing for a snug approximation. Note that this rectangle has a |
| | wider upper dimension than lower, protruding 3 inches beyond the edge of |
| | the base platform, and three inches toward the center wedge. As described |
| | below, this is creating and open space for the patient's lower extremities. |
| 4 | This will simply be a pump access valve which allows for tubing connection |
| | and positive pressure air flow. |
| 5 | The carrying case will be a clear plastic envelope 15 by 15 by three inches |
| | with a flap that contains a snap to maintain the cleanliness of the inside |
| | deflated device. There will be a tab on the top as well as a hook and |
| | adhesive wall mount to allow for this case to be mounted against a crash |
| | cart. The devices name and logo will be printed on the case. |

### Detailed Description of the Parts of the Invention

### Relationship Between the Parts of the Invention

The completed compilation of this entity will create a leg raise where a patient is laying supine (on their back), with their thighs at a 45-degree angle (angled upwards), and then their lower legs resting on the plateau of the device parallel with ground level. The three wedges, oriented in upside-down triangle formations, connect to the plateau of the base air bladder, extending upwards to form a workspace 8 inches above the bases plateau. The wedge formation leaves room for the patient's lower extremities to rest beneath the workspace.

The center wedge will have a width of connection to the base of four inches, running the length of the bases plateau and extending two inches over the 45-degree angle. The two outside wedges will have 6 inches of connection with the bases plateau, running the length of the bases plateau beginning at the width ends of the plateau and extending 6 inches inwards. This leaves 12 inches for each of the patient's lower extremities, with the opening narrowing to a point 6 inches above the plateau, with the remaining two inches in height for approximation between the center wedge and the two outside wedge entities. This will serve as a snug stabilization connection, to facilitate a sturdier work station platform.

The platform will be 30 inches in length and 42 inches in width. The footprint dimensions of the base will be 36 inches in length by 36 inches in width.

### Details of the Invention Operation/Functions

The function of this device is to serve as an assistant to the code, rapid response, or sepsis teams of a healthcare setting. This device contributes in two main capacities. The first is to serve the role of one and sometimes two individuals on the care team, raising the patient's legs, providing roughly 2 liters of volume resuscitation. Often this benefit is foregone, given the lack of personnel and space in the room. The second function is to provide a workspace, desperately needed during these events. The workspace forms over the top of the patient's lower extremities, high value real estate in the center of the room, yet previously inaccessible due to lack of efficient and functional use.

The operation of this device entails removing the deflated air bladder/balloon from it's carrying case. This carrying case is mounted on the side of a crash cart, the mobile unit utilized when a code or sepsis team is activated. The deflated balloon is positioned beneath the patient's legs, with the base at the patient's heels/end of the bed, and the other end of the length positioned beneath the patient's sit bones, where the patient's thighs begin/gluteal fold. Tubing will be connected from the port of the air bladder to either compressed air on the wall or to an external mobile pump attachment. The patient's lower extremities will be enveloped by the wedges as they inflate inform the workstation above with the patient's legs tucked safely inside in a leg raise formation.

1. And inflatable air bladder, serving an overall function of performing a leg raise while also providing a workspace platform, comprising: a base air bladder consisting of oh an angled surface to raise the thighs and flat plateau for the lower extremities; a center wedge to inflate between the lower extremities and create the central portion of the workspace table; and outside wedges filling on the outer edges of the base plateau surrounding the lower extremities from the outside and creating the outer segments of the workspace table.
